(19) United States
(12) Patent Application Publication
(10) Pub. No.: US 2004/0201622 A1
(43) Pub. Date: Oct. 14, 2004

(54) Free-form routing of physical and electronic documents

(75) Inventors: Bradley Rhodes, Palo Alto, CA (US); Gregory Wolff, Redwood City, CA (US); Kevin Ridout, Campbell, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Ricoh Company, Ltd., Tokyo (JP)

(21) Appl. No.: 10/098,868

(22) Filed: Mar. 15, 2002

(51) Int. Cl. G09G 5/00

(52) U.S. Cl. 345/751; 345/709; 709/201; 715/530

(57) ABSTRACT

A document distribution system provides free form routing of documents through the system. Recipients can annotate documents, and track their progress through the system. Flexibility of routing is provided by facilities which allow recipients, as well as the originating user, to modify the document routing through the system.

### CROSS-REFERENCES TO RELATED APPLICATIONS

NOT APPLICABLE

### REFERENCE TO A “SEQUENCE LISTING,” A TABLE, OR A COMPUTER PROGRAM LISTING APPENDIX SUBMITTED ON A COMPACT DISK.

NOT APPLICABLE

### BACKGROUND OF THE INVENTION

The present invention relates to document management systems and more generally to systems and methods for document flow processing and tracking.

Business documents often follow a set route, or flow, through a company. For example, a purchase request will be authored by an employee, receive comments and approval from a manager, and the sent to a purchasing department for final processing. In the case of a purchase request, the document typically has a very clearly defined route.

However, other documents can have a more free form flow through the company. For example, a draft of a new policy statement might be distributed to all managers within a department for comments before being forwarded to upper management. As comments come in some managers may want to distribute the document more widely, requesting comment from their own working groups. If the scope of the policy statement changes in the course of the comments period, people from other departments may be included in the discussion.

The comment or review period for a particular document can last anywhere from days to months depending on the number of people involved and the number of comments and signatures required. As a result of such delays, it is often difficult to manage the progress of a project.

Many businesses have not made the transition to a paperless office. Many documents and business practices are still conducted by paper, and even when a document exists in electronic form some people prefer to mark up physical paper copies rather than comment on an electronic version.

There is a need to facilitate the flow of information embodied in documents and to accommodate the flow of physical documents.

### BRIEF SUMMARY OF THE INVENTION

A document distribution system and method includes receiving documents for distribution and a distribution list. The documents are distributed according to the distribution list. Recipients can annotate the documents and perform other actions on the documents. In addition, recipients can modify the distribution list to alter the flow of the documents through the system.

### BRIEF DESCRIPTION OF THE DRAWINGS

The teachings of the present invention can be readily understood by considering the following detailed description in conjunction with the accompanying drawings:

FIG. 1 shows a generalized distribution flow of a document according to embodiments of the present invention;

FIG. 2 shows a high level communication network in accordance with embodiments of the present invention;

FIG. 3 is a high level flow chart illustrating typical processing in accordance with embodiments of the present invention;

FIG. 4 illustrates daisy-chain processing in accordance with embodiments of the invention;

FIG. 5 represents a screenshot image illustrating various graphical elements for data output and data input which comprise a user interface for document route creation according to a particular implementation of the present invention;

FIG. 6 represents a screenshot image illustrating various graphical elements for data output and data input which comprise a user interface for visualizing a created document route according to a particular implementation of the present invention;

FIG. 7 represents a screenshot image illustrating various graphical elements for data output and data input which comprise a user interface for document route notification according to a particular implementation of the present invention;

FIG. 8 represents a screenshot image illustrating various graphical elements for data output and data input which comprise a user interface for setting document router preferences according to a particular implementation of the present invention;

FIG. 9 represents a screenshot image illustrating various graphical elements for data output and data input which comprise a user interface for viewing pending routes according to a particular implementation of the present invention;

FIG. 10 represents a screenshot image illustrating various graphical elements for data output and data input which comprise a user interface for route visualization and editing according to a particular implementation of the present invention;

FIGS. 11A and 11B represent a sequence of screenshot images illustrating how a document is modified;

FIG. 12A and 12B represent a sequence of screenshot images illustrating how a route is modified; and

FIG. 13 represents a screenshot image illustrating how the route proceeds to the next stage.

### DETAILED DESCRIPTION OF THE INVENTION

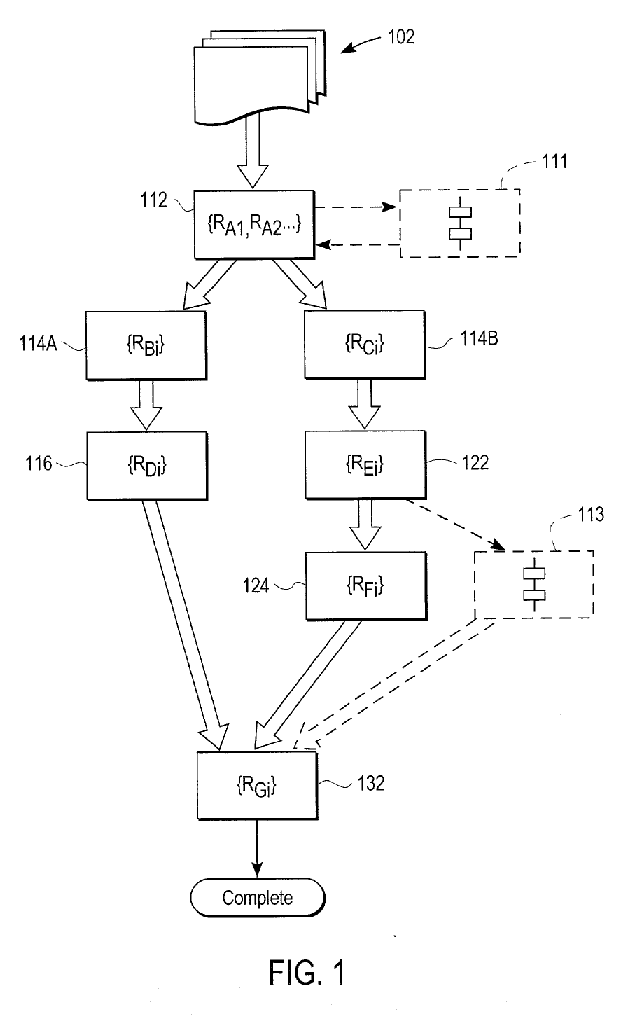

Referring to FIG. 1, a schematic representation of document flow in a document distribution system according to an illustrative embodiment of the present invention is shown. One or more documents 102 (collectively referred to as a document resource) intended for distribution are processed in stages, which constitute a route (routing) that the documents take during their journey through the distribution system. Depending on implementation details, either an identifier of the documents can be passed around, or copies of the documents themselves. Each stage is represented in FIG. 1 by a box; e.g., stage 112, stage 114A, stage and so on. Each stage is characterized by having associated with it a set of one or more recipients (distribution list), e.g. stage 112 comprises recipients represented by RA, stage 116 comprises recipients RB, and so on. Typically, the recipient is a human user. However, it is possible for a computing device or other automated machine to be a “recipient” of documents 102. The particular route shown in FIG. 1 of course is merely an illustrative example and intended to show various aspects of the invention.

Each stage is further characterized by having associated with it a set of conditions or criteria which control the flow of the documents 102 through the distribution route. As will be discussed in more detail, typical routing criteria involve various actions performed by the recipients. For example, simple actions might be to read the documents (or simply to have opened the documents, presumably for reading), or to “sign off” on the documents (e.g., a purchase request or expense report may need to be signed off by a manager). The routing criteria are based on the occurrence or nonoccurrence of such actions. Satisfaction of these criteria allow the documents to proceed to subsequent stages. For example, at stage 114A, the documents would be distributed to stage 116 on the condition that all of the recipients RD have signed off on the documents.

Conditional processing includes providing alternate routing of the documents 102 to subsequent stages based on meeting or not meeting certain criteria in the current stage. An example of this aspect of the invention is illustrated in FIG. 1 by stages 112, 114A and 114B. Suppose the documents arrive at stage 112. The recipients RA will review the documents and take certain actions (e.g., open the documents, sign off, annotate, and so on). The routing criteria can be defined such that if recipients RA1 and RA2 sign off, then the documents are distributed to a first segment of the route which includes stage 114A; and if recipients RA1 and RA3 sign off, then the documents are distributed a second segment which includes stage 114B. Stage 112 can be referred to as a branch point in the distribution route.

A further aspect of the invention is shown in FIG. 1, wherein recipients are allowed to modify the document routing. Thus, consider the situation in stage 112. A recipient who receives the documents 102 in stage 112 may be allowed to modify the routing by adding a new segment 111 to the route. The new segment can be any arbitrary route, including straight segments and branch points. The new segment is shown departing from stage 112 and returning to stage 112. FIG. 1 illustrates that new segments can be added in other ways. For example, segment 113 can depart from a first stage (e.g., stage 122) and continue elsewhere in the distribution route (e.g., stage 132).

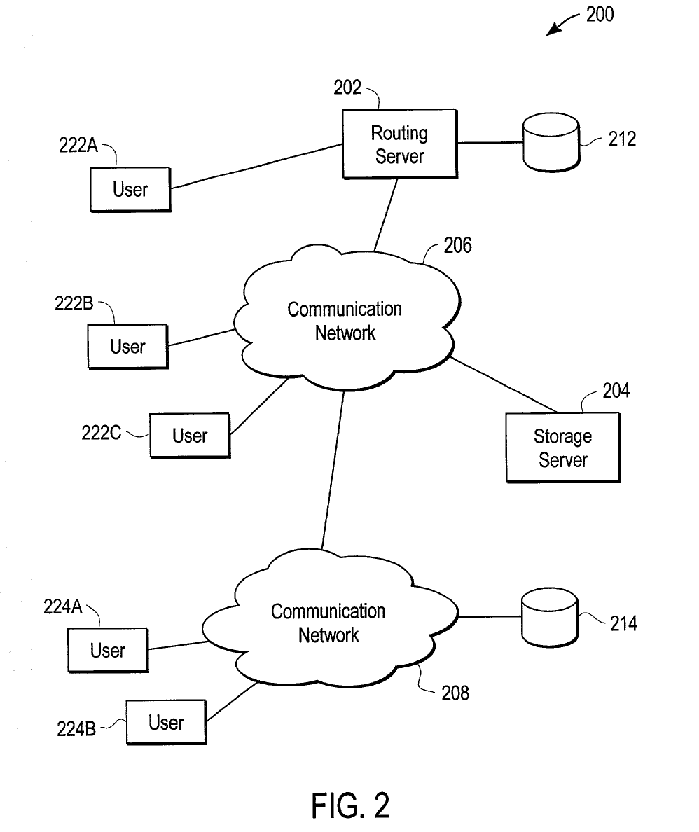

FIG. 2 is a high level system architecture, showing the typical components which comprise the distribution system. In the disclosed embodiment, a routing server 202 comprising various computing machinery and software components cooperate to provide the functionality of the document distribution system. In a specific embodiment, the routing server can be a single computer running the appropriate software. In a large enterprise, the routing server can be many cooperating machines operating together to perform the functions of the distribution system. The specific configuration and hardware needs are not relevant the practice of the invention.

The routing server 202 is connect to a communication network 206. Typically, this might be a wide area network (WAN). However, it is understood of course that the particular communication network is not relevant to practicing the invention and can be of any architecture such as a local area network (LAN), a virtual personal network (VPN), and so on.

A storage component 212 can be provided for use by the routing server. The storage component 212 is intended to provide local storage for the routing server 202, to meet the storage needs of the software components executing on the routing server. Depending on the particular architecture and implementation, the storage component 212 can be a device that is connected to the WAN or a local area network (LAN).

A storage server 204 can be provided to serve as a large scale storage facility for the documents that are created, distributed, and otherwise managed by the distribution system. The storage server 204 can be connected to the communication network 206 and thus be in communication with the routing server 202. The routing server and storage server cooperate to provide the distribution services of the distribution system.

The single storage server configuration shown in FIG. 2 is suitable for legacy storage systems. For example, storage server 204 might be a pre-existing storage server system, having accumulated many documents over time. For example, in a particular implementation, a commercially available system component called eCabinet® manufactured and sold by the assignee of the present invention serves as one such legacy system. The routing device 202 can be readily integrated with the pre-existing storage server system to provide a document distribution system according to the present invention by simply accessing the storage server over an appropriate communication channel, such as a WAN, LAN, and so on. Other configurations include an all-in-one system, where the routing server component 202 and the storage server component 204 do not communicate over a network. Documents to be managed can be distributed among multiple storage server systems in a distributed storage architecture. For example, a storage component 214 might be located on a separate communication network 208. The routing server 202 could be given access to this storage component as a source and destination for documents handled by the document distribution system. Embodiments of the present invention can accommodate such distributed architectures and other configurations.

Users 222 can access the routing server 202 in any of known conventional ways. A user 222A can have a direct (or local) access to the routing server. Typically, users 222B, 222C will access the routing server via the communication network 206. Users 224A, 224B might access the routing server from within a local communication network 208 (e.g., LAN).

Any of a number of known communication protocols can be used. For example, the routing server 202 can be a web-based machine providing document distribution services to users using HTTP (hypertext transport protocol), Javascripts, and so on. Communication between the routing server 202 and the storage server 204 can be based on conventional networked file system protocols; e.g., NFS (networked file system), AFS (Andrew file system). Other file transfer protocols can also be used, including conventional protocols such as FTP (file transfer protocol), RCP (remote copy), and SCP (secure remote copy). The storage server could also be a database such as Oracle or other SQL database. The storage server could even be a web server, using HTTP as the transport protocol. It can be appreciated that these and other configurations are possible.

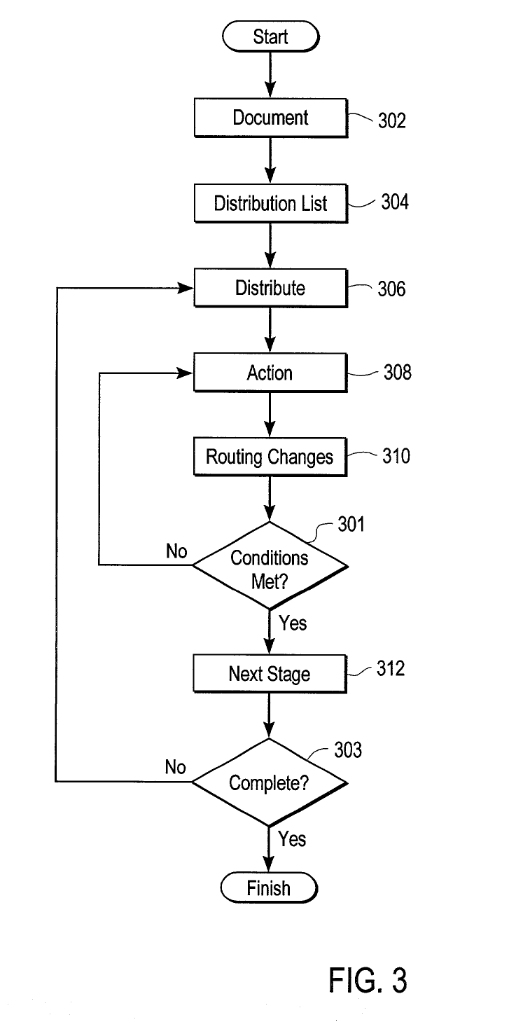

FIG. 3 shows a high level flow chart illustrating the general processing steps for document distribution processing in accordance with an embodiment of the invention. First, a step 302, one or more documents are specified for distribution by an originating user this can be in the form of a document resource identifier which maps to the document(s). The document can be a text document, or a multimedia file. The document can be produced by scanning in a physical document. The “user” can be a machine that generates documents for distribution; e.g., an automated system for generating budgets; a fault detection system which produces a report upon detection of a fault; a periodic maintenance report generated by an automated maintenance component in a large system.

In step 304, a distribution list is associated with the document(s). The distribution list specifies the recipients of the material, the routing of the document among the recipients (document route), and the conditions which control the progress of the routing of the documents. The distribution list can be a pre-defined list, or can be produced by the user. The distribution list can even be programmatically generated, for example based on the contents of the routed document(s).

The distribution list also includes information indicative of distribution (routing) criteria. The distribution criteria control the flow of documents from one stage to the next along the document route. The criteria associated with a given stage must be met before the documents are distributed to a subsequent stage. For example, a common condition is the requirement that a particular recipient or recipients must sign off on the document. Branching conditions can be employed to determine which of a number of possible subsequent stages will receive the documents. For example, if recipients Alice and Bob at stage X sign off on a document, then the document should proceed to stage Y, comprising recipients Carol and Don. On the other hand if only Alice signs off on the document, then the document should proceed to stage Z, comprising recipients Ernie and Fred. As another example, if Alice signs off and Bob doesn't read it within a certain period of time after being notified, then the document goes to stage Q: Bob's partner. Logical operations can be provided. For example, as a prerequisite for a document to proceed to a subsequent stage, the document can be signed off by (Alice and Bob) or by (Greg and Harry). It can be seen that the criteria can be based on a wide range of conditions, event occurrences, timed events, and so on, and can include logical connectors.

Continuing with FIG. 3, the documents are delivered to the recipients comprising the first stage, step 306. This can entail a variety of possible activities. In one embodiment of the invention, the routing server 202 can access the storage server 204 to obtain the documents and deliver copies to each recipient in the current stage. This can be accomplished, for example, by emailing the documents as one or more attachments to the recipients. Alternatively, the routing server can deposit the documents in known locations (e.g., a storage server or similar file server system) and notify the recipients of the documents and their location by email. Still another delivery method would be to communicate a URL via email, by an instant messaging technique, and the like. The URL can be the document router page information showing the whole route, including a link to download the document.

As with the originating user, the recipient user can be a machine that receives the document and performs automated processing on the document. The machine can take certain actions upon receiving the document. For example, an automated purchasing system might initiate a purchase order with a vendor upon receiving a properly signed off document.

Each recipient can perform any of a number of actions on the documents, step 308. A typical action item is to “sign off” on the documents. This can be accomplished by producing a hardcopy of the document and literally signing or initializing the document. The signed document is then scanned back into the system for subsequent distribution. Various digital signing techniques are known. For example, the recipient cold create a digital signature using his private key from a public/private key pair, using a public key encryption system such as RSA or DSA. Digital signatures would be stored by the system. As another example, the system might provide a password-protected mechanism which allows the recipient to indicate that the document is to be signed by that recipient. The system can then associate appropriate information with the document which indicates that the recipient has signed off on the document.

Another common action is to annotate the document in some manner. The document can be annotated with comments/corrections by any appropriate document editor. Text, audio, and visual information can be added to the document. Alternatively, a copy of the document to be annotated can be made and the annotations are made to the copy. The annotated copy can then be distributed with the “root” document, the root document being the original document or documents originally selected for distribution. In still another alternative, comments/corrections can be kept in a separate document and linked into the root document. This approach preserves the original root document, while allowing for comments. As another method of annotation, a hardcopy of the document can be produced. The recipient can mark up the hardcopy with comments and other information. The marked up copy can then be scanned back into the system and subsequently distributed along with the root document.

A document might be a paper or electronic form with check boxes, or fill-in-the-blanks, or the like. The action here would be to make the appropriate checks and fill in the requested information. Another action can be to associate related documents with the root document. Related documents might include physical documents which are scanned in. Subsequent distribution would then include the related documents in addition to the root document.

Yet another action can be to mark the document as “refused to sign off.” This might be used to indicate rejection of a proposal or some such matter. For example, a purchase order request might be rejected by a manager. A refusal to sign off type of action would be appropriate for this situation. Still another action can be to indicate “signature not required.” This might be useful if a person appears twice on the route. She might elect not to see the subsequent version.

It can be appreciated that various other actions appropriate for the enterprise can be incorporated into the document distribution system according to the present invention.

Tracking numbers can be used to track comments or additional documents that are added to the route. In one embodiment of the invention, the routing server provides the tracking number or other similar information. In an embodiment where the routing server is integrated with a legacy storage system, the tracking number or similar information can be provided by the latter, giving more flexibility in implementation.

Continuing with FIG. 3, recipients are allowed to alter the distribution list, step 310. Recipients can be added to a stage, or deleted from a stage. Stages can be inserted between existing stages. Stages can be deleted. The routing conditions within a stage can be altered. Additional segments can be added to the distribution list, as shown in FIG. 1.

In an embodiment, the routing information is stored as metadata associated with the documents being routed. Modifications to the route amount to making modifications to the metadata. In an architecture where a storage server (e.g., 204, FIG. 2) separate from the routing server is provided for the documents, the metadata can be stored at the storage server. Similarly, where the routing server is implemented on top of a legacy storage system or other similar system containing documents to be routed, the metadata can be stored on the legacy storage system. Additionally, several pieces of routing information can be stored both on the routing server (e.g., in a database in the routing server) and on the legacy storage system. In a particular implementation in accordance with an embodiment of the present invention, the following routing information is duplicated:

whether a document is an original “root” document or a commented or otherwise annotated document

whether a root document is pending a recipient's signature

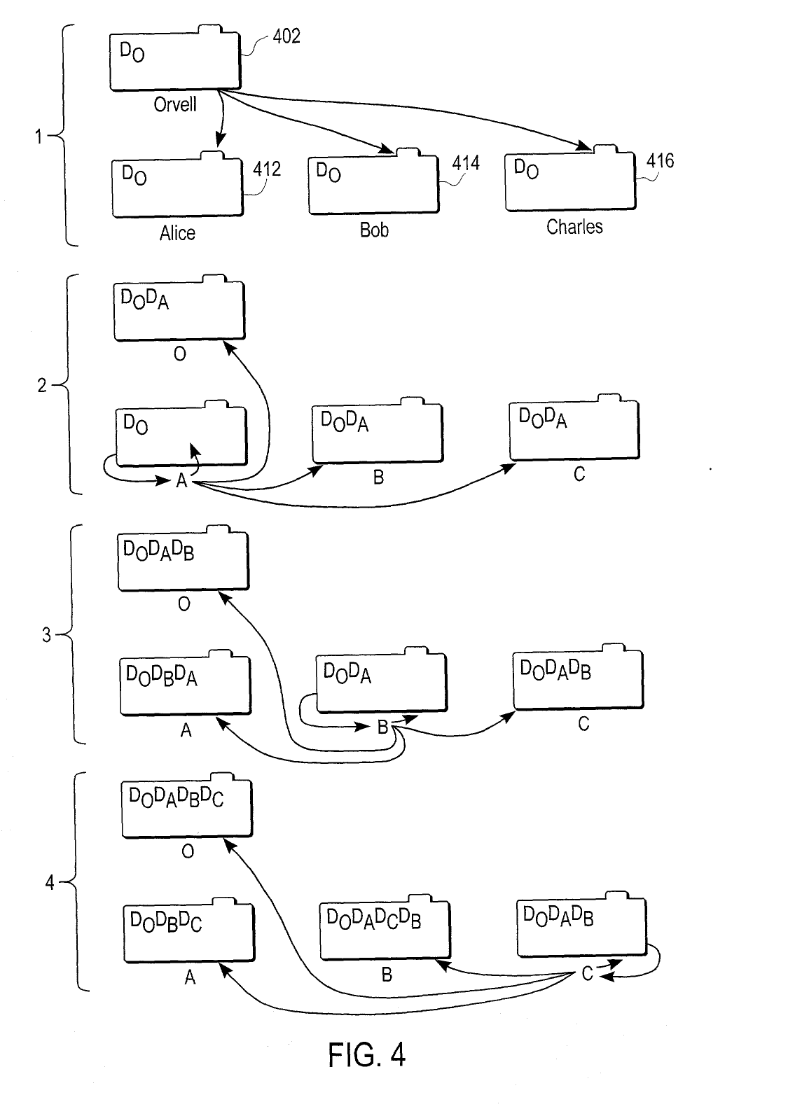

a pointer (e.g., serial number in the eCabinet® X system) to the original version of this document; i.e., the one that was originally copied in a daisy-chain distribution manner (see FIG. 4 below)

whether a root document is part of a route that is open, closed, or abandoned

Of course, additional information can be duplicated as deemed appropriate in any given particular implementation.

Such duplication of the metadata may be appropriate where searches for open routes or routes pending a signature can be performed on either the routing server or the legacy storage system. In a particular implementation that includes eCabinet® , for example, the legacy system has built-in search functions that allow easy queries for the routes. A similar functionality would be available if email was used as a write-only storage and transport mechanism.

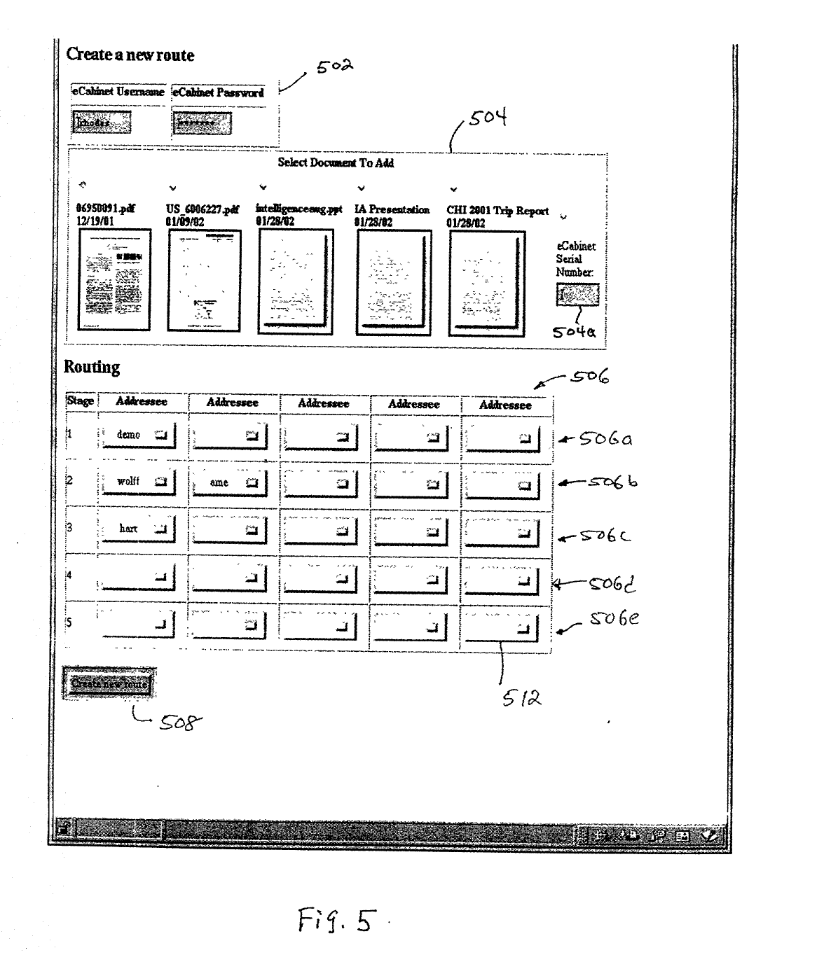

The metadata can also include information that allows a user on the legacy system to link back to the routing server. As will be discussed in connection with FIGS. 5 and following, a particular implementation in accordance with an embodiment of the invention include a user interface on the routing server, specifically a web-based interface, that provides a set of tools for managing a route. The metadata can include a URL which allows software local to the legacy system to access a web page on the routing server which serves as an entry point to the user interface. For example, a browser-type application running on the legacy system can display the metadata URL as a link to the user interface routines on the routing server.

Permissions are provided to limit the scope of modifications that can be made by the recipients. Some recipients, e.g., high level managers, system administrators, and the like, may have unrestricted access. The system can also log and possibly display the history of what changes had been made, and by whom. Access to such information can of course be subject to permissions.

Distribution of the documents within a stage is complete when the routing criteria (conditions) for that stage are met, step 301. If the conditions are not met then processing continues in the current stage. For example, a modification to the routing conditions by a recipient may require that the documents be reconsidered by the recipients. As a specific example, a purchase order for an item may be deemed unusual by a group leader recipient. The group leader could modify the routing conditions to require that the purchasing manager review and sign off on the purchase order before the purchase order proceeds to the next stage.

When the routing conditions for the given stage are met, then next stage is determined. The selection can depend on which conditions are met, in the case of a branch point (see FIG. 1). If the selected stage indicates completion, step 303, then distribution is complete. A notification can be sent to the originator of the documents upon completion of the distribution cycle. If the selected stage is another stage in the distribution route, the processing continues with step 306, where the document(s) is distributed to the recipients in the next stage, annotations and related documents. In an embodiment of the invention, the originating user also receives the annotations and other documents added by the recipients.

In step 306, one form of distribution included copying the documents to specific locations accessible by the recipient and the user. Referring now to FIG. 4, a copy technique called daisy-chain copying is shown. The technique provides secured annotations to documents.

FIG. 4 illustrates the copying sequence. In step 1, a root document DO is copied from the directory (folder) 412 of an originating user Orvell to a first stage in the distribution list. In the example shown in the figure, the first stage comprises recipients Alice, Bob, and Charles. The root document is copied to their respective directories 412, 414, and 416. Each directory has the characteristic that while its owner has read and write access to her directory, everyone else has write-only access. In some legacy storage systems (e.g., eCabinet®), the storage facility provides “add-only” capability, which is the ability for non-owners of a storagespace to add a document/file, but not to modify it, read it, or delete it after it has been deposit. Thus, Alice has full access to her directory 412, though Orvell, Bob, and Charles have write-only access. Directories 414 and 416 are similarly configured. In a particular implementation, the directories can be directories in a file system, or database tables, email, inboxes, or other storage partitions.

In step 2, Alice reads the root document D_{O} and annotates it or otherwise associates additional information with it. This additional information is represented by document D_{A}. The document D_{A} is distributed to the other recipients and to originator Orvell. In step 3, Bob reads the root document and/or Alice's annotations/additions. Any of Bob's comments are placed in document D_{B}. The document is then distributed to Orvell, Alice, and Charles. Finally in step 4, Charles reads some or all of documents D₀, D_{A}, and D_{B} and make his own comments. These comments are stored in document D_{C} and distributed to Orvell, Alice, and Bob. Upon completing the conditions for the first stage, the documents D₀, D_{A}, D_{B}, and D_{C}are copied to the recipients of the next stage from Charles' copies in his storage server.

The daisy-chain copying technique is suitable for a file transport or storage system that is distributed. Full file access is limited to the owner, while allowing others only the ability to deposit files.

Referring to FIG. 5, a user interface 500 is shown for interacting with the document distribution system. The interface allows an originator of the documents to create or otherwise specify the document(s) for distribution. The interface provides tools for creating or otherwise specifying the distribution list. Related tools are provided which facilitate management of the distribution list, including making modifications to the distribution list. Tools are provided which allow the originator and possibly recipients to track the progress of documents in the document distribution system.

Typically, the user interface is a graphics-based interface providing areas for presenting information about the progress of the distribution of the documents. The user interface can manifest itself in other forms such as a pure voice-based interface, or a combination of voice and graphics, and so on. The specific choice of interface will depend largely on the nature of the information being exchanged. For example, a pure voice interface would be appropriate for user who call into the system by telephone where the information of interest might be information about who has reviewed or signed off on a particular document. The discussion which follows describes a general diagrammatic representation of a graphical user interface, illustrating the tools relevant to the document distribution system.

The following figures describe user interface features for providing access to the various aspects and capabilities of the invention. In this particular implementation of the document router, the system is incorporated in the commercially available system component manufactured and sold by the assignee of the present invention, called eCabinet®. The interface is implemented as a web page.

FIG. 5 shows a screenshot image illustrating various graphical elements for data output and data input which comprise a user interface (web page, etc.) for document route creation according to a particular implementation of the present invention. A login area 502 accepts a username and a password of a who wants to create a new route. Here, a user “rhodes” has logged in.

A “last 5” list shows the last five documents accessed by user “rhodes.” Document access can include printing, scanning, photocopying, uploading, or any other activity. As can be seen user “rhodes” can select a document from the “last 5” list. If the document is not in the “last 5”, the user can obtain another list. In this particular embodiment, the eCabinet® uses a serial number to identify a list. Thus a selection area 504a can be provided for this purpose.

A route selection area 506 arranged in a tabular format conveniently organizes the stages of the route into rows 506a -506e. Each column in a row contains a pulldown menu 512 for selecting a recipient. The route selection area shows a table for five stages and five recipients per stage. However, additional stages and recipients can be accommodated by providing a scrolling mechanism (e.g., conventional window scroll bars). The figure shows that user “rhodes” has defined a three stage route. The first stage 506a includes a recipient “demo.” The second stage 506b includes two recipients “wolff” and “name.” Finally, a third stage 506c includes recipient “hart.” A button 508 is accessed by the user to create the route; e.g., by “clicking” on the button.

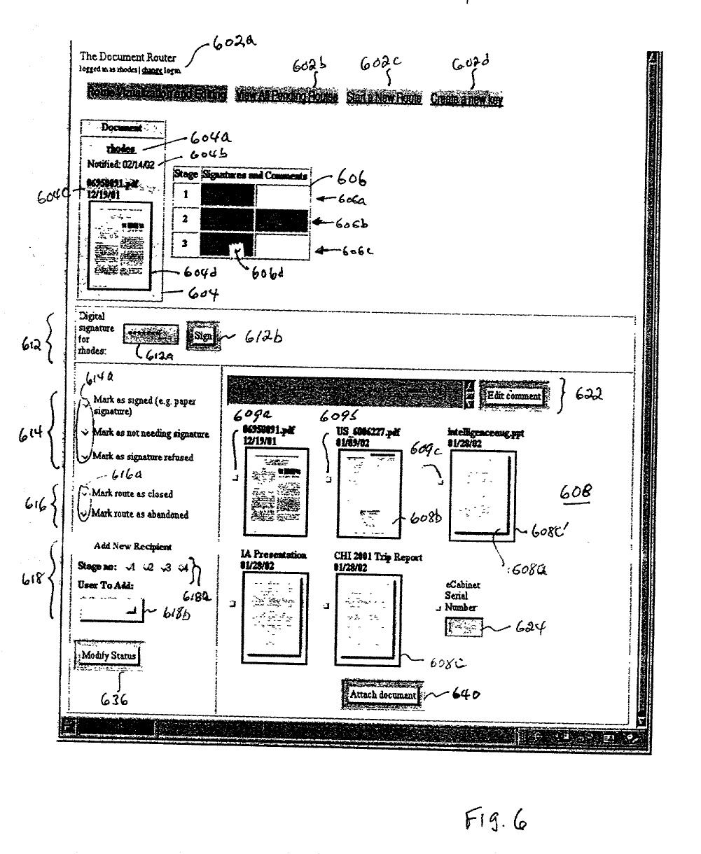

FIG. 6 represents a screenshot image illustrating various graphical elements for data output and data input which comprise a user interface (web page, etc.) for visualizing a created document route according to a particular implementation of the present invention. This is the visualization and editing page. It is a page that can be accessed by any user, or alternatively only by users who are recipients on this route. However, the particular example shown in FIG. 6 represents owner of the route. The page is displayed to the owner when she creates the route by pressing the create button 508 shown in FIG. 5.

Buttons located near the top of the interface include a login button 602a which allows different users to log on. A “view pending routes” button 602b allows a user to navigate to a page to view information relating to a pending route (i.e., a route in which not everyone has signed off or otherwise viewed the documents constituting a resource being routed). A “new route” button 602c navigates the user to the page shown in FIG. 5. A “new key” button 602d gets a user to a page where the user can specify one or more keys for the various encryption techniques that can be employed.

An owner information area 604 presents owner information 604a indicating the owner of the route. Information about the document being routed 604d includes a notification date 604b. In this initial route creation case, the notification date simply refers to the time that user “rhodes” clicked on the create button 508 in FIG. 5 to get to the page shown in FIG. 6. In addition, to the notification date, the date of creation of the document and its filename 604b, 604c are provided.

The document being routed can be read by “single-clicking” on the document. Recall, in this particular embodiment, the interface is a web page. The graphic representing the document 604d to be routed is a hyperlink to the actual document. If multiple documents are being routed they can be displayed side-by-side in the owner information area 604, allowing the logged in user to access the other documents. In the case of multiple documents attached as comments or annotations, discussed below, such documents also can be displayed in a side-by-side manner.

A recipient information area 606 shows the route in tabular form. Each stage occupies a row 606a -606c. Each row show the recipients in that stage. A scrolling graphic can be presented to show additional stages and/or recipients. Shading and/or color conventions can be adopted to indicate the actions recipients have taken. For example, one color might be used to indicate the recipient has not been notified of a document. Another color may be used to indicate the recipient has been notified, but has not opened the document. Still another color can be used to indicate the recipient has been notified, has opened, but has not signed off on the document, and so on. Another convention might be to use gradual fills of the area 606d containing the recipient name to graphically indicate the progress of the routing for each recipient.

When the user displaying this page is either the owner or is a recipient, that user's name will be highlighted or otherwise indicated. If the user is the owner, then that owner's name in the owner information area 604 will be highlighted. If the user is a recipient, then that recipient's name in the recipient information area 606 will be highlighted. In addition, certain actions taken by the “highlighted user” will be reflected in her name area (604a, 606).

The particular example shown in FIG. 6 represents a situation where the page is being displayed by the owner of the route. Thus, the owner information 604a can be highlighted or otherwise set apart from the other information being displayed; for example by displaying the name in a different color, a different font, a different background, and so on.

A signature area 612 provides a signature mechanism for digitally signing the document 604d. A password field 612a allows the user to enter a password to authenticate the user. A signature button 612b digitally signs the document. This can be accomplished using conventional digital signature techniques, or by any agreed-upon protocol which may or may not involve encryption processing.

An secondary signature area 614 allows a user to take alternate action other than digital signing. Radio buttons 614a (or other similar input graphics) are provided allowing a user to select actions such as “mark as signed” which is appropriate for situations in which a hardcopy of the document is signed. A “signature not needed” button allows the user has deemed her signature not to be needed. A “refusal” button allows the user to indicate the she has refused to sign the document.

When a signature action is taken (in areas 612 or 614), the action can be reflected in the name area (604a, 606) of the highlighted user.

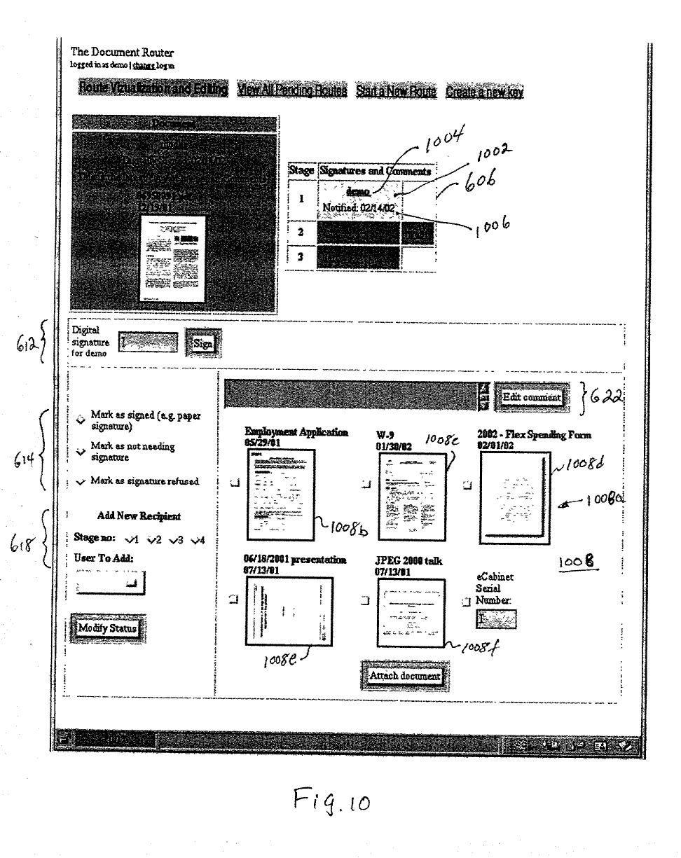

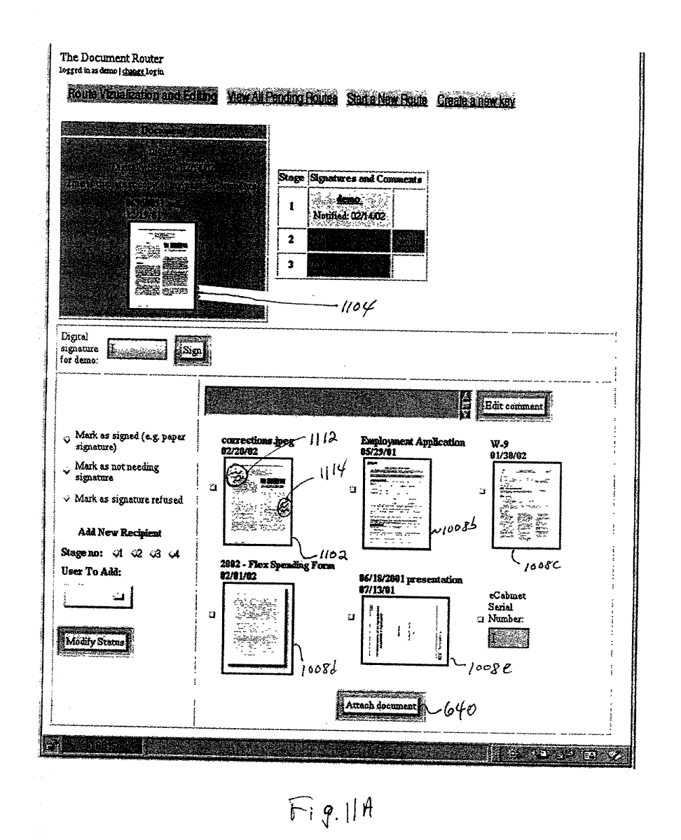

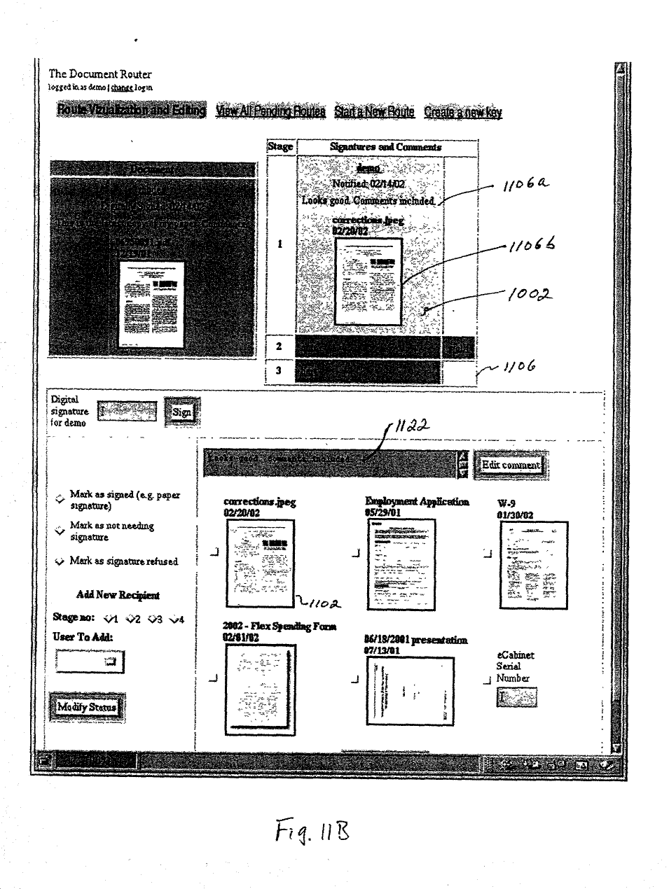

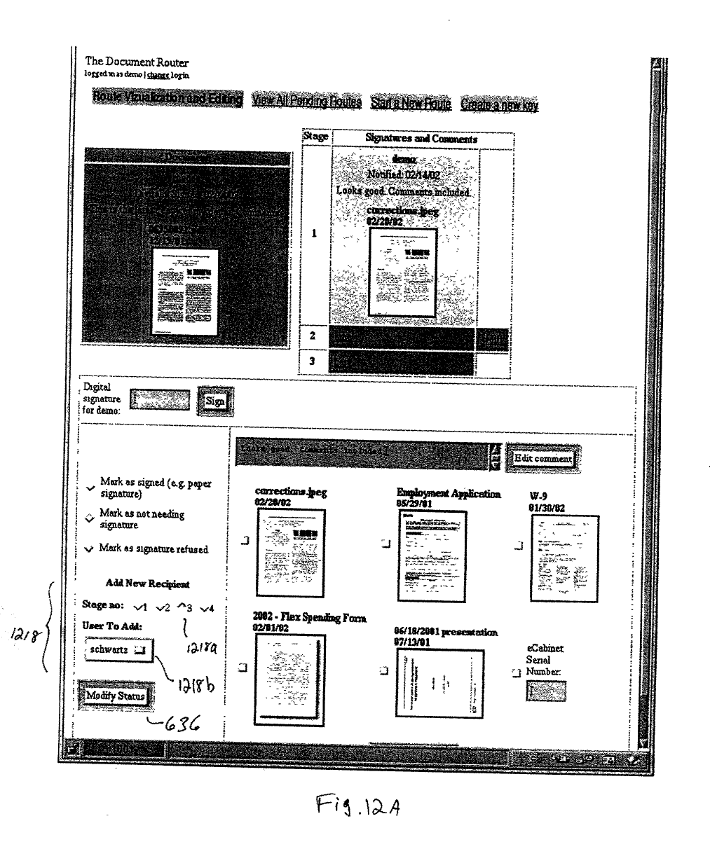

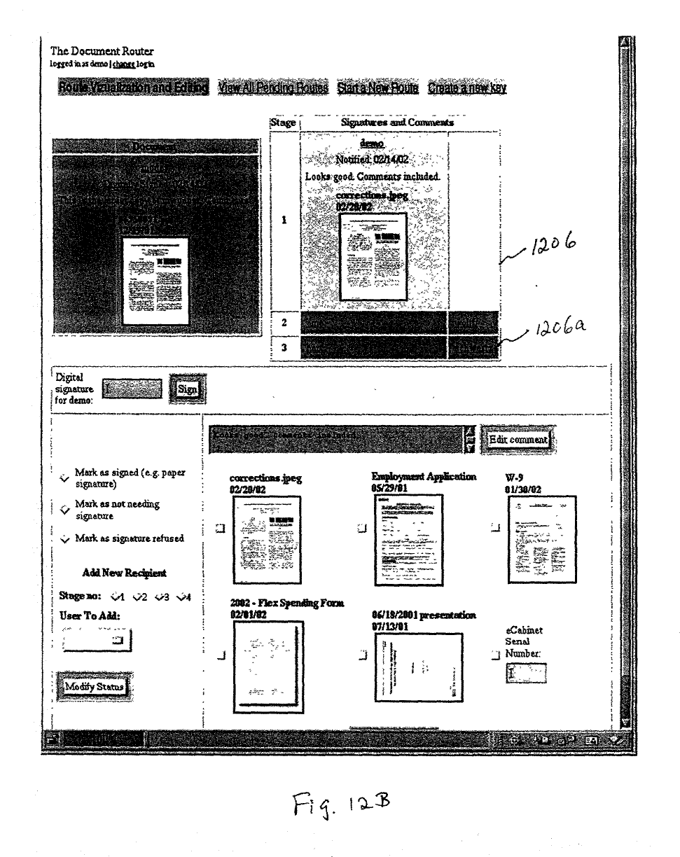

A route management area 616 allows the owner of the route to mark the route as closed or abandoned. Some radio buttons 616a or other equivalent input graphics are provided. In the screenshot shown in FIG. 6, it is the owner “rhodes” of the route who has reached the page being shown. Thus, the route management area is presented. If a non-owning user of a route accesses this page, this area is not displayed (e.g., FIG. 10).

A route modification area 618 allows a user (whether owner or non-owner) to modify a route. As mentioned above, system level privileges can be provided to prevent a user from having such editing access. A set of buttons 618a specify which stage is to be modified. A dropdown menu 618b is provided to allow selection of a recipient to be added to the selected stage in the route.

A modify button 636 allows the user to make effective the actions made in areas 614, 616, and 618. When the action is taken (in areas 612 or 614), it can be reflected in the name area (604a, 606) of the highlighted user.

A comment area 622 allows a user to associate a comment to the document 604d shown in the owner information area 604. The comment can appear in the name area (604a, 606) of the highlighted user.

A document attachment area 608 allows additional documents to be associated with the resource. A “last 5” list can be presented in this area showing the last five documents accessed by the logged in user. A selection area 624 can be provided so that the user can specify another list. Each document is displayed with an icon 608b. The icon can be a thumbnail image of the first page of the document, as in icon 608b. However, if it is not possible to produce such an image, then a generic icon 608a can be displayed. If a document can be opened (and typically they should be) for viewing, it is highlighted 608c. The document can be opened by single-clicking. Similar to a web page conventions, a previously opened document can be indicated by highlighting with a different color, or some shading or the like.

Each document has an associated selection checkbox, e.g., 609a -609c. A document can be selected for attachment by “clicking” on its associated checkbox. Finally, an attach button 640 effects the logical action of attaching each selected document to the route.

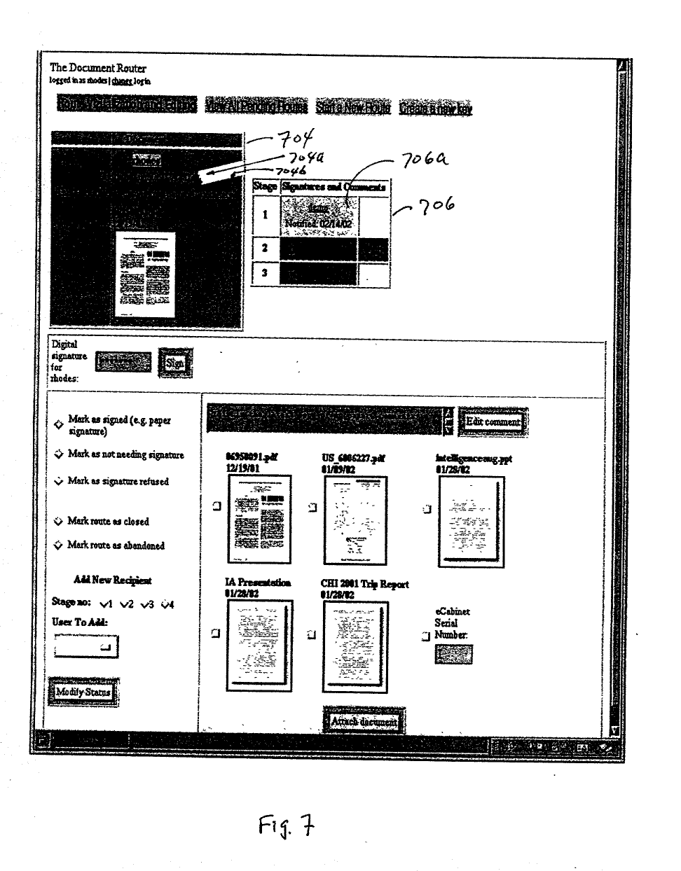

FIG. 7 represents a screenshot image illustrating various graphical elements for data output and data input which comprise a user interface for document route notification according to a particular implementation of the present invention. This page shows the changes which occur to the page shown in FIG. 6 when user “rhodes” has signed off on his document. Recall from FIG. 5 that user “rhodes” created a route. FIG. 6 shows the page that is presented when the create button 508 is pressed, thus creating the route. Next in the process is to initiate the routing. This is accomplished when the owner (here, user “rhodes”) signs off on his own document(s). FIG. 7 shows the result of that action.

The owner information area 704 indicates that user “rhodes” has signed off on his own initial documents, thus initiating the route. The sign-off date 704a is shown in the owner information area, along with a comment 704b supplied by user “rhodes.” The sign-off date also includes the manner by which the signing occurred, digital or paper signed. The owner area can be presented with shading or some coloring convention to indicate the that the owner has signed off.

The recipient information area 706 now indicates that the document(s) have passed to the recipients in stage 1. The area 706a for recipient “demo” now contains a notification date, indicating when notification took place. This area can be filled with shading or a coloring convention to indicate different degrees of progress during routing.

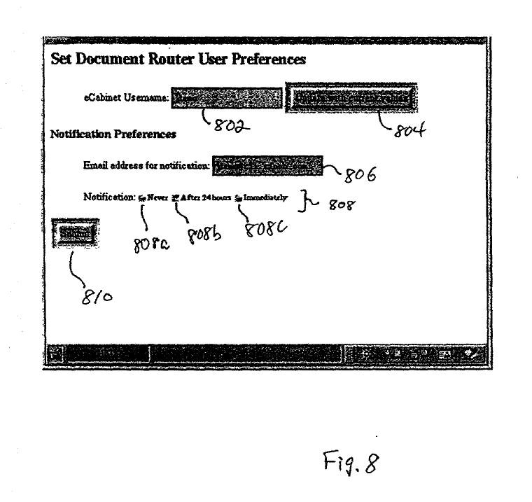

FIG. 8 represents a screenshot image illustrating various graphical elements for data output and data input which comprise a user interface for setting document router preferences according to a particular implementation of the present invention. This page allows a user to change her notification preferences. The user enters her user id in the input field 802. An email address input field 806 allows the user to specify an email address for receiving notification. A notification delay area 808 allows the user to specify via radio buttons 808a -808c the desired notification timing for documents awaiting her signature. A 24-hour notification might be useful if the user normally checks her “pending routes” page daily, but sometimes forgets.

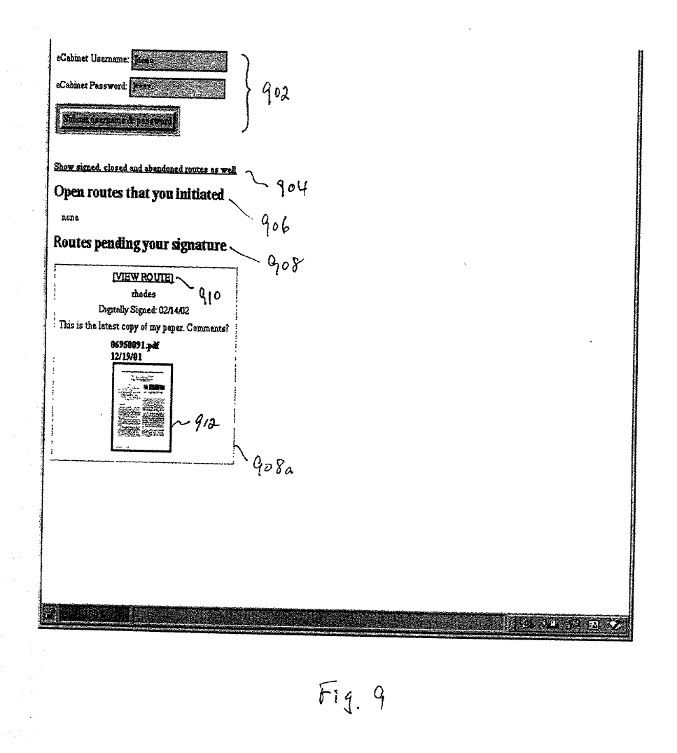

FIG. 9 represents a screenshot image illustrating various graphical elements for data output and data input which comprise a user interface for viewing pending routes according to a particular implementation of the present invention. This page allows a user to view routes with documents awaiting her action, along with information about her own routes. A log-in area 902 allows a user to login to the system. A hyperlink area 904 allows the user to view no longer active routes, such as signed routes, closed routes, and abandoned routes. Signed routes are those routes the document(s) of which have been signed by the user. An open routes area 906 displays the user's own routes. The example shown in FIG. 9 indicates that user “demo” has no open routes.

A pending routes area 908 shows the routes which are pending waiting for the user to sign off. Here, user “demo” has one pending route 908a. Additional pending routes would be displayed in side-by-side fashion. A scrolling graphic can be provided if more routes than can be displayed are pending. Information relating to a pending route 908a includes the owner of the route, the sign off date (by the owner) of the document in the route and an associated comment by the owner, and the creation date of the document. If additional documents are contained in the route, an appropriate input graphic can be provided to access the additional documents. The document icon 912 can be single-clicked to display the entire document.

FIG. 10 represents a screenshot image illustrating various graphical elements for data output and data input which comprise a user interface for route visualization and editing according to a particular implementation of the present invention. This figure represents the page presented to a logged-in user who does not own a route, e.g., user “demo.” As discussed above in FIG. 6, since logged in user “demo” is also a recipient, his name 1004 in the recipient information area 606 will be highlighted is some manner. In addition, certain actions, such as signing (area 612) or commenting will be reflected in his name area 1002. The document attachment area 1008 shows a “last 5” list specific to user “demo.” Note that the route management area 616 is not presented, since user “demo” is not the owner of the route (user “rhodes” is), but only a recipient. The remaining areas of the page shown in the figure behave in the manner as described in FIG. 6.

FIGS. 11A and 11B show a sequence illustrating a scenario where user “demo” has modified a document. FIG. 11A shows that the routed document 1104 has been printed and marked up in pen 1112, 1114, and subsequently scanned in. The marked up document 1102 appears in the “last 5” list. Note that the documents 1008b -1008e in FIG. 10 are shifted down by one spot, where document 1008f has rolled off the “last 5” list. The newly marked up document 1102 has been inserted in the position previously occupied by 1008b, indicating that it is now the most recently accessed document in the “last 5” list. Alternatively, the routed document 1104 could have been opened up with an appropriate program, modified, and then saved as modified document 1102.

FIG. 11B shows the result of user “demo” having selected the modified document 1102 and clicked on the attach button 640. The consequence of that action is for the name area 1102 of user “demo” to be updated with an icon 1106b of the modified document 1102. The figure shows further that user “demo” has added a comment 1122. This action also shows up in the name area 1102 as a comment 1106a.

FIG. 12A and 12B shows a sequence of screenshot images illustrating how a recipient can modify a route. Thus, in FIG. 12A user “demo” has selected to modify stage 3 by clicking on the button 1218a. Then the dropdown menu 1218b was manipulated to selected user “schwartz.” Upon clicking the modify button 636, the action shown in FIG. 12B occurs. The recipient information area 1206 is updated to reflect the user “shwartz” has been added as a recipient at stage 3 in the route. The interface shown in the figure does not show who modified the route. However, this information can be (and in this particular implementation is) retained in an appropriate data store. Moreover, the interface can be modified accordingly to provide this information if the needed.

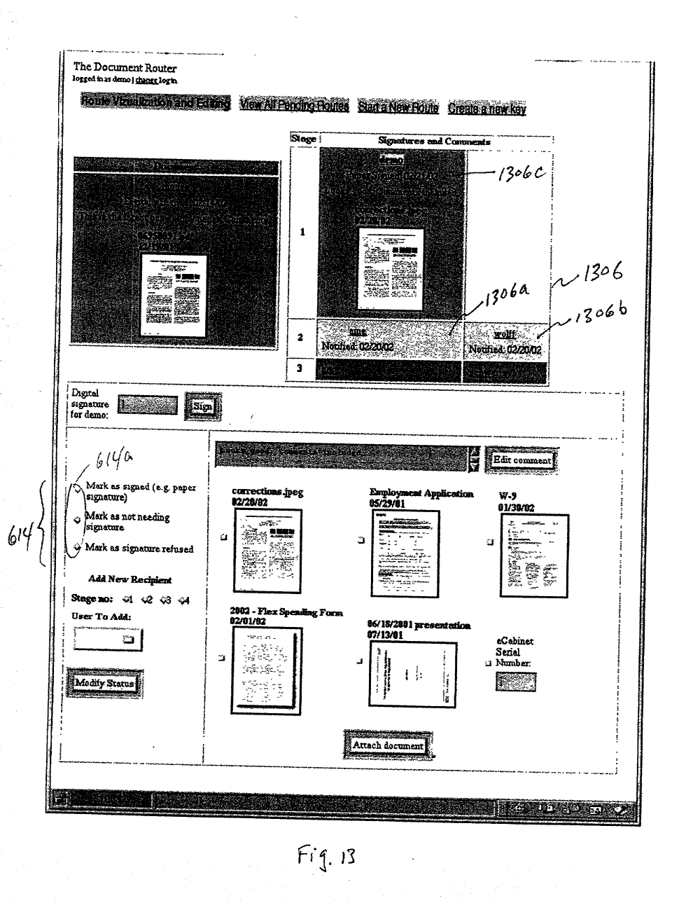

FIG. 13 represents a screenshot image illustrating how the route proceeds to the next stage. Here, it can be seen that user “demo” has signed off on his changes by signing a hardcopy of the marked up document. The user indicates that a document is marked as signed by depressing the appropriate button 614a in the alternate signature area 614. This action is indicated in the recipient information area 1306, in the name area 1306c for user “demo.”

In addition, since user “demo” is the only (and hence the last) recipient in stage 1, his action of signing completes the routing in stage 1. The recipients in stage 2, namely, “name” and “wolff” are notified automatically. This action is indicated in their respective name areas 1306a, 1306b, which now contain the notification date information. Furthermore, the name areas are shaded or colored differently to emphasize that the routing has proceeded to the next stage.

What is claimed is:

1. A method for routing documents comprising:
receiving a document resource, said document resource representative of one or more documents for distribution;
receiving distribution information comprising one or more recipients, said distribution information including a plurality of stages, each stage having one or more recipients;
distributing said document resource to first recipients of a first stage, said first recipients performing one or more actions on said one or more documents; and
subsequent to performing said one or more actions, distributing said document resource to second recipients of a second stage, said second recipients performing said one or more actions on said one or more documents,
wherein said document resource is eventually distributed to last recipients in a last stage, said last recipients performing said one or more actions on said one or more documents.

2. The method of claim 1 further including presenting prompting information to said recipients and inputting said one or more actions at a first computer system and storing said one or more documents at a second computer system.

3. The method of claim 2 wherein said presenting prompting information includes obtaining document information from said second computer system relating to said one or more documents and presenting said document information at said first computer system.

4. The method of claim 1 wherein said document resource comprises a plurality of identifiers which identify said one or more documents.

5. The method of claim 1 wherein said one or more actions includes receiving from a recipient modifications to said distribution information.

6. The method of claim 1 wherein said distribution information comprises metadata associated with said document resource, and said one or more actions includes receiving modifications from a recipient indicative of changes to said metadata.

7. The method of claim 6 wherein said step of receiving modifications is performed at a first computer system, the method further including storing said metadata and said changes to said metadata on a second computer system.

8. The method of claim 7 wherein said metadata includes link-back information indicative of said first computer system, the method further including accessing said first computer system from said second computer system based on said link-back information to perform said one or more actions on said one or more documents.

9. The method of claim 8 wherein said link-back information is a web page on said first computer system.

10. The method of claim 1 wherein said one or more actions includes receiving from a recipient one or more document identifiers for subsequent distribution.

11. The method of claim 1 wherein said one or more actions includes receiving from a recipient information to be associated with said one or more documents.

12. The method of claim 1 wherein said steps of distributing include daisy-chain copying.

13. The method of claim 1 wherein said one or more actions are performed at a first computer system said one or more documents are stored at a second computer system.

14. The method of claim 13 wherein said document resource comprises a plurality of identifiers which identify said one or more documents, said identifiers being produced at said second computer system.

15. The method of claim 13 further including communicating information between said first computer system and said second computer system using HTTP (hypertext transport protocol).

16. The method of claim 13 further including receiving at said second computer system user requests to search files stored therein and receiving at said second computer system user requests to perform said one or more actions at said first computer system.

17. A method for routing documents comprising:
receiving a document resource, said document resource having an associated owner;
associating a distribution list to said document resource, said distribution list comprising one or more recipients and one or more routing conditions;
distributing said document resource to said one or more recipients in accordance with said distribution list and said routing conditions; and
receiving from said one or more recipients information to modify said routing conditions,
wherein said distributing is performed in accordance with said distribution list and said routing conditions as modified.

18. The method of claim 17 wherein said document resource is a document to be distributed.

19. The method of claim 17 wherein said document resource is a document identifier of a document.

20. The method of claim 17 further including receiving routing information from said owner, said routing information indicative of said distribution list.

21. The method of claim 17 wherein said document resource is produced by scanning a physical document.

22. The method of claim 17 further including receiving from said recipients one or more modifications to one or more documents corresponding to said document resource and distributing said one or more modifications along with said document resource.

23. The method of claim 17 further including receiving first information relating to recipients who have received said document and second information relating to actions performed upon said document by said recipients, and making available said first and said second information to said owner.

24. A method for routing documents comprising:
receiving a first document resource, said first document resource having an associated owner;
receiving first information representative of a document route, said document route comprising one or more distribution steps, each distribution step having associated recipients;
receiving second information representative of distribution criteria, each said distribution step further having corresponding distribution criteria;
distributing said first document resource to first associated recipients of a first distribution step; and
distributing said first document resource to second associated recipients of a subsequent distribution step in accordance with modified first corresponding criteria, said modified first corresponding criteria being a result of modifications received from one or more of said first associated recipients.

25. The method of claim 24 further including receiving third information relating to said first document resource from said first associated recipients, said distributing including distributing said third information along with said first document resource.

26. The method of claim 25 wherein said third information is a scanned document representative of a marked-up version of a papercopy of a document corresponding to said first document resource.

27. The method of claim 25 wherein said third information is a second document resource.

28. The method of claim 25 further including incorporating said third information with a document corresponding to said first document thereby producing a modified document, said distributing including distributing said modified document.

29. The method of claim 28 said distributing said modified document is a step of distributing an identifier associated with said modified document.

30. A system for distributing documents comprising:
a computer system, said computer system having a communication component operable to communicate with one or more users;
first program code configured to operate said computer system to receive a document, said document having an associated owner;
second program code configured to operate said computer system to receive a distribution list, said distribution list comprising one or more recipients;
third program code configured to operate said computer system to distribute said document to said one or more recipients in accordance with said distribution list; and
fourth program code configured to operate said computer system to receive from said one or more recipients information representative of one or more modifications to said distribution list.

31. The system of claim 30 wherein said communication component is further configured to communicate with a second computer system for purposes of receiving and distributing said document.

32. The system of claim 30 further including a storage component for purposes of storing and distributing said document.

33. The system of claim 30 further including fifth program code configured to operate said computer system to receive first information relating to recipients who have received said document and second information relating to actions taken on said document by said recipients, and sixth program code configured to operate said computer system to present said first information and said second information to said owner.

34. A document distribution apparatus comprising:
means for receiving a document for distribution;
means for receiving a list of one or more recipients of said document;
means for receiving a set of distribution criteria;
means for distributing said document to said one or more recipients in accordance with said distribution list and said distribution criteria; and
means for receiving from said one or more recipients one or more modifications to said distribution list or to said distribution criteria,
wherein said means for distributing includes distributing said documents in accordance with said distribution list and said distribution criteria as modified.

35. The apparatus of claim 34 further including means for receiving related information and associating said related information with said document, said means for distributing including distributing said related information along with said document.

36. The apparatus of claim 35 wherein said related information includes one or more annotations on said document or one or more additional documents.

37. The apparatus of claim 34 further including means for receiving and presenting first information relating to recipients who have received said document and second information relating to actions taken by recipients who have provided related information associated with said document.

38. A user interface for document routing comprising:
a first information exchange portion for presenting a document, said document having an associated owner, said document having an associated document route comprising one or more recipients;
a second information exchange portion to present said document route;
a third information exchange portion to obtain related information associated with said document; and
a fourth information exchange portion which allows said owner and said one or more recipients to modify either or both said document route.

39. The user interface of claim 38 further including a fifth information exchange portion to present distribution information relating to the distribution of said document among said one or more recipients.

40. The user interface of claim 38 further including a fifth information exchange portion to present modifications made to said document route.

41. The user interface of claim 38 further including a fifth information exchange portion to receive an action associated with said document.

42. The user interface of claim 38 further including a computer display, wherein said information exchange portions comprise a plurality of computer graphic elements displayed on said computer display.

43. A computer program product for distributing documents comprising:
a computer usable medium having computer readable program code, said computer readable program code suitable for execution on a computer system, said computer readable program code comprising:
first program code configured to operate said computer system to receive a document, said document having an associated owner;
second program code configured to operate said computer system to receive a list of one or more recipients;
third program code configured to operate said computer system to receive routing conditions;
fourth program code configured to operate said computer system to distribute said document to said one or more recipients in accordance with said routing conditions; and
fifth program code configured to operate said computer system to receive from said one or more recipients information representative of one or more modifications to said list or to said routing conditions.
